(19) United States
(12) Patent Application Publication
(10) Pub. No.: US 2013/0019735 A1
(43) Pub. Date: Jan. 24, 2013

(54) Machine Tool, Especially Hand-Held Machine Tool

(71) Applicants: Thilo Koeder, Tokong (MY); Joachim Platzer, Remseck-Hochberg (DE); Jan Koegel, Oak Park, IL (US)

(72) Inventors: Thilo Koeder, Tokong (MY); Joachim Platzer, Remseck-Hochberg (DE); Jan Koegel, Oak Park, IL (US)

(73) Assignee: ROBERT BOSCH GMBH, STUTTGART (DE)

(21) Appl. No.: 13/515,743

(22) PCT Filed: Oct. 22, 2010
(86) PCT No.: PCT/EP10/65953

§ 371 Date: Oct. 1, 2012

(30) Foreign Application Priority Data
Dec. 16, 2009 (DE) 10 2009 054 709.6

(51) Int. Cl. B26D 1/00; G01S 15/08; H04N 7/18

(52) U.S. Cl. 83/697; 348/135; 367/99; 348/E07.085

(57) ABSTRACT

A hand-held machine tool such as a jigsaw includes a distance measuring unit for the contactless detection of a section of a specified path and for visualizing a working path corresponding to the specified path and/or for aligning the machine tool including its working tool with the working path corresponding to the shape of the specified path by means of an adjusting device.

The invention relates to a power tool, in particular a hand-held power tool, as per the preamble of claim 1 or 2.

### PRIOR ART

Power tools of the abovementioned kind are frequently used in practice, in particular as jigsaws, and are equipped with an auxiliary device in order for their work tool to operate along a work path which is located in an offset position with respect to a specified path that extends in a laterally offset manner with respect to the power tool. This auxiliary device comprises a guide shoe which is provided in a laterally projecting manner with respect to the power tool, is arranged on an extension arm that is adjustable in relation to the power tool and is supported in a movably guided manner along the specified path parallel to the work path. For example, an edge of the workpiece, a guide strip or the like serves as the specified path.

The handling of such mechanical auxiliary devices is limited with respect to the possible uses thereof, they are often awkward, and not infrequently obstructive in operation. In particular, they require additional attention on the part of the user of the power tool, since, in order to guide the work tool, the user also has to monitor the specified path and check that the guide shoe is exactly following the specified path.

### DISCLOSURE OF THE INVENTION

The invention is based on the object of creating simplified preconditions for the following of a work path that is located in an offset position with respect to a specified path that extends in a laterally offset manner with respect to the power tool.

This object is achieved according to the invention firstly by the features of claim 1, according to which a course section of the specified path and the distance of the work tool from the specified path in this course section is sensed via a contactlessly operating distance measuring unit and the work path which corresponds to the specified path at a specified distance and is to be followed by the work tool is presented via a display device.

The contactless sensing of the course of the specified path located in a laterally offset manner with respect to the power tool and the distance of said specified path from the work tool can be carried out optically, for example via a sensor system, in particular in the form of a camera or laser, or else by acoustic means, for example via an ultrasonic measuring unit. Further contactlessly operating measuring devices, for example measuring devices that operate on the basis of radio waves, can also be used. The work path corresponding to the specified path can be displayed optically, either by presenting the work path as a signal beam or by projecting a work line corresponding to the work path onto the respective workpiece. This provides the user firstly with the possibility of aligning the work tool of the power tool with the work path and machining the workpiece along the work path. The work path specified in a virtual manner, either as a signal beam or by projection onto the workpiece, can furthermore be used, given appropriate equipping of the power tool, to align the work tool, i.e. in particular the jigsaw blade in the case of jigsaws, with the work path, in particular in semi-autonomous operation and given appropriate basic alignment of the power tool, and to guide it along the work path, so that, on the basis of the presentation of the work path located in an offset position with respect to the specified path, the work path is indirectly followed via the machine-side adjustment of the work tool, and the user of the power tool can also monitor the following of this work path. This monitoring can optionally also be achieved and/or intensified by indications of the position of the work tool with respect to the work path, for example in display presentations.

The abovementioned object is also achieved as per claim 2 in that, in addition to the by a distance measuring unit for contactlessly sensing a course section of a specified path that extends in a laterally offset manner with respect to the power tool and the distance of the work tool from the specified path, an actuating device for aligning the work tool with the work path and/or for guiding the work tool along the work path, which extends at a specified distance from the specified path, is provided as auxiliary device. The starting point for this solution is the direct use of the data for controlling the actuating device, said data describing the work path with respect to its course corresponding to the specified path and also with respect to its distance from the specified path, to the effect that the work tool follows the work path, this also allowing semi-autonomous operation. In conjunction therewith, it proves to be expedient for the work path corresponding to the specified path also to be presented via a display device, as outlined above, as a result of which the image presented to the user on the workpiece side, irrespective of offset operation, ultimately corresponds to that which the user finds in the case of a work path that is indicated as a marking line on the workpiece.

The configuration, provided according to the invention, of a power tool proves to be expedient in particular for electrically operated, hand-held jigsaws, which are equipped with a saw blade, which is rotatable about its stroke axis, as work tool, and in the case of which the work path, which is sensed by sensors, for example via a camera, is traced by the saw blade by corresponding machine setting of the rotary position, to which end the data sensed by sensors are converted, in a computer-aided manner, via an evaluating unit, into actuating commands for an actuating device that rotates the saw blade. Thus, in a power tool configured according to the invention, semi-autonomous operation is possible even in the event of tracing of a work path located in an offset position with respect to a specified path, specifically without any additional marking on the workpiece.

In the solution according to the invention, the specified path can be formed by contours, such as edges, on the workpiece side, by markings provided on the workpiece, or else by characteristic surface structures. Given appropriate positioning of the workpiece, the specified path can also be formed by parts which are located adjacent to the workpiece, such as walls or the like, as a result of which it is, for example, possible, in the case of a workpiece positioned adjacent to a wall and the use of the wall surface as specified path, to cut an edge of the workpiece in a manner corresponding to the wall contour and thus, even in the case of irregular wall surfaces and wall contours, achieve optimum matching by a work path corresponding to the specified path.

With regard to the diverse use of the power tool even in the case of spatially offset courses of specified path and work path, such as of a workpiece with respect to an adjacent wall, it proves to be expedient for the distance measuring unit to be arranged in an adjustable manner with respect to the power tool and so, for example, its sensor system can be positioned in different manners for the specified path. If appropriate, the distance measuring unit, given flexible connection in particular of its sensor system to the power tool, can also be connected in a spatially offset manner in particular to the housing of the power tool, for example by plugging on, in order to achieve an in each case optimized position in relation to the respective specified path. In this case, it proves to be expedient for illumination at least of the respectively sensed course section of the specified path also to be carried out, if appropriate in combination with the sensor system, for instance, in particular, by an illuminating unit assigned spatially to the sensor system.

Further advantages and expedient embodiments can be gathered from the further claims, the description of the figures and the drawings, in which:

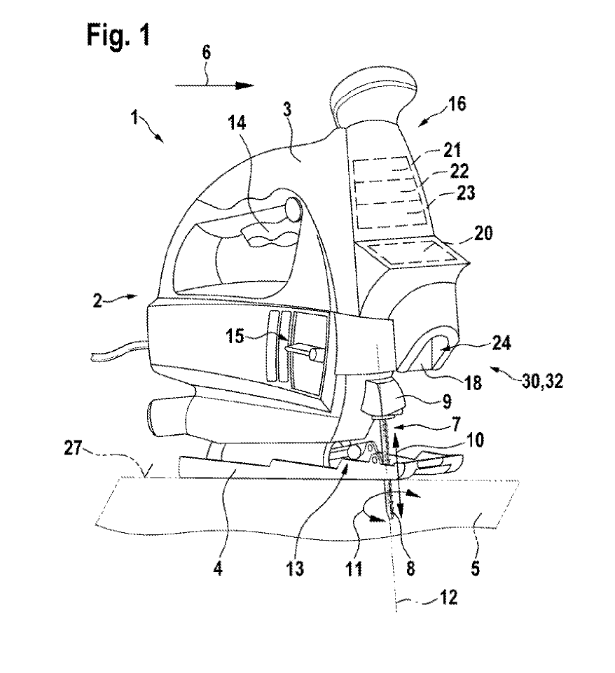

FIG. 1 shows a perspective illustration of a jigsaw, as an example of a hand-held power tool, positioned on a workpiece, and

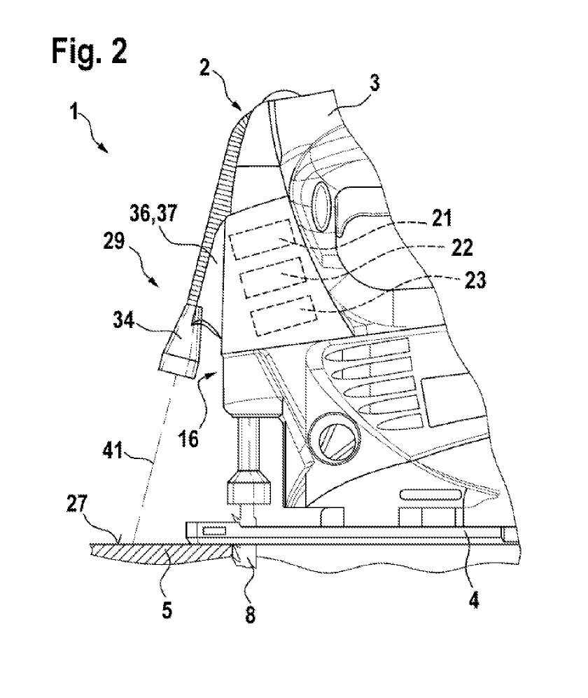

FIGS. 2 to 6 show various views of different, schematic partial illustrations of jigsaws having a distance measuring unit provided on the jigsaw.

FIG. 1 first of all illustrates the basic structure of a hand-held jigsaw 2 as an example of a power tool 1. The jigsaw 2 has a housing 3, which is movably supported via a sole plate 4 on the surface of a workpiece 5. As work tool 7, for which a work plane is specified by its shape, the jigsaw 2 has a saw blade 8. The saw blade 8 is held in a tool holder 9 and is driven in a reciprocating manner in the direction of the arrow 10. The stroke axis of the saw blade 8 coincides in the illustration with a rotational axis 12, about which, with regard to the exemplary embodiment illustrated, the saw blade 8 is rotatable, as indicated by the arrow 11. The respective sawing direction is specified as working direction via the rotary position of the saw blade 8. The working direction indicated by the arrow 6 corresponds to the straight-on working direction of the jigsaw 2 which coincides with the work plane of the saw blade 8 in its neutral central position, that is to say with the saw blade 8 unrotated.

Proceeding from a basic structure of the jigsaw 2 and a corresponding alignment of the saw blade 8, said alignment corresponding as normal working position to the straight-on working direction according to arrow 6, the rotatability of the saw blade 8 about the rotational axis 12 in accordance with the arrow 11 opens up the possibility of operating the jigsaw 2 in a different operating mode, namely as what is known as a “scrolling jigsaw”. In this operating mode, the jigsaw can also operate in the direction of a rotary position, deviating from the straight-on working direction, of the saw blade 8, that is to say at an angle, corresponding to the rotary position of the saw blade 8, to the straight-on working direction as normal working position. This occurs semi-autonomously in that the saw blade 8 mechanically follows a respectively specified, straight or curved work path to be traced in a manner aligned therewith, with the user essentially only supporting the reaction forces that result from operation and also the advancing of the jigsaw 2.

If appropriate, the jigsaw 2 can also be operated in what is known as a pendulum stroke mode for the machinery illustrated in FIG. 1. In this case, the saw blade is adjusted in a pendulous manner, in a manner superimposed on the stroke drive, via a pendulum drive 13 in the direction of its saw-blade plane as respective work plane.

The various operating modes can be set by the user via a switch device 15. The jigsaw 2 is switched on and off via a switch arrangement 14 provided in the handle region of its housing 3.

An above-discussed, at least semi-autonomous operating mode with the machine following a with regard to a work path to be followed necessitates a corresponding specification for this work path and also means for specifying and/or sensing this work path.

In this regard, with regard to the machine structure, the illustration according to FIG. 1 is based on the fact that such a work path specified for example by a marking on the workpiece surface 27 is detected and sensed via an optical sensing unit 30. The latter is illustrated in the front region 16 of the housing 3 on the workpiece-side work region of the saw blade 8, and thus aligned with the work path. The optical sensing unit 30 comprises at least one sensor system 18, optionally also in the form of a camera, which is aligned with the workpiece-side work region of the saw blade 8 and the work path running through the latter. Optionally, as indicated, a further sensor system and/or an illuminating arrangement 24, for instance in the form of a signal beam emitter, which is aligned with the work region of the saw blade 8 and the work path running through the latter, can also be arranged, in particular in the region of the sensor system 18. Data sensed via the sensor system 18, optionally also via other sensor systems, can be evaluated individually or combined in a subordinate manner and to this end a computing unit 21, a control unit 22 and at least one actuating device 23 are provided for processing the corresponding signals, with the actuating device 23 being used in particular to set the work tool 7 in the form of the saw blade 8 to its respective rotary position and/or to hold it in its respective rotary position.

The sensed data can also be processed graphically, as a further aid for the user, and converted into information for the user, as is indicated in FIG. 1 by the illustration of a display 20. This makes it possible, for example, to indicate the alignment of the saw blade 8 in relation to the respective work path and thus also to provide the user with information as to the direction in which the jigsaw 2 should be supported or moved.

When the jigsaw 2 is equipped with a computing unit 21, as has just been described, said jigsaw 2 already has one of the preconditions for enabling a considerable widening of its use spectrum with little outlay, in that it is equipped with a distance measuring unit 29 as an auxiliary device for the contactless sensing of a course section of a specified path 31 which is located in a laterally offset manner with respect to the jigsaw 2 and which makes it possible, in conjunction with a display device 32, to display a work path 33 (FIGS. 2 to 4) which is located in an offset position with respect to the specified path 31 and is to be followed by the saw blade 8 as work tool 7. In a corresponding manner, depending on the specifications, which were determined via the distance measuring unit, for the work path 33, in particular using data processed in the computing unit 21, the actuating device 23 can also be controlled such that the saw blade 8 follows along the work path 33 located in the offset position with respect to the specified path 31 and/or operates in a manner aligned therewith, wherein at least semi-autonomous operation should be realized even in the case of offset operation.

The display device 32 used can be, although not illustrated in more detail, for example an illuminating arrangement 24 in the form of a signal beam emitter or an illumination source which, in a similar manner to the virtual signal beam, optically images a work path 33 parallel to the specified path 31.

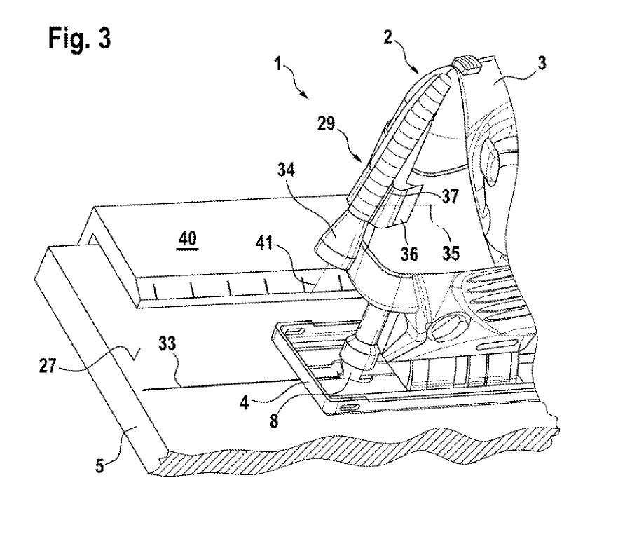

The distance measuring unit 29 is illustrated in a schematic manner in FIGS. 3 to 6 with a sensing arrangement 34 which, with respect to these exemplary embodiments, for the sake of simplified illustration, is shown in a manner arranged exclusively at the front, and preferably longitudinally centrally at the front. However, other possible ways of arranging it, for example eccentrically at the front or else to the side on the housing 3, are possible and, depending on specific applications, also expedient as the case may be. However, in particular the arrangement longitudinally centrally at the front affords versatility of adaptation to the respective requirements, in particular when the sensing arrangement 34, as indicated for example in FIG. 3, is pivotable about an axis 35 to extend a longitudinal direction of the jigsaw 2. Such a pivotable arrangement is not difficult to realize and is optionally also provided in conjunction with a holding part 37 which is pivotable about the axis 35 with respect to a housing-side base part 36, can be fixed, in particular latched, in various pivot positions, and to which the sensing arrangement 34 can be fixed, preferably in a detachable manner. A simple possibility in this respect consists in forming the holding part 37 with a dovetailed insertion guide for the sensing arrangement 34. Other configurations in this regard are within the scope of the invention. A mount, formed by the base part 36 and holding part 37, for the sensing arrangement 34 can optionally be provided in addition at another point, for example to the side of the housing 3, such that preparations are made for fixing the sensing arrangement 34 at different fastening locations on the jigsaw 2.

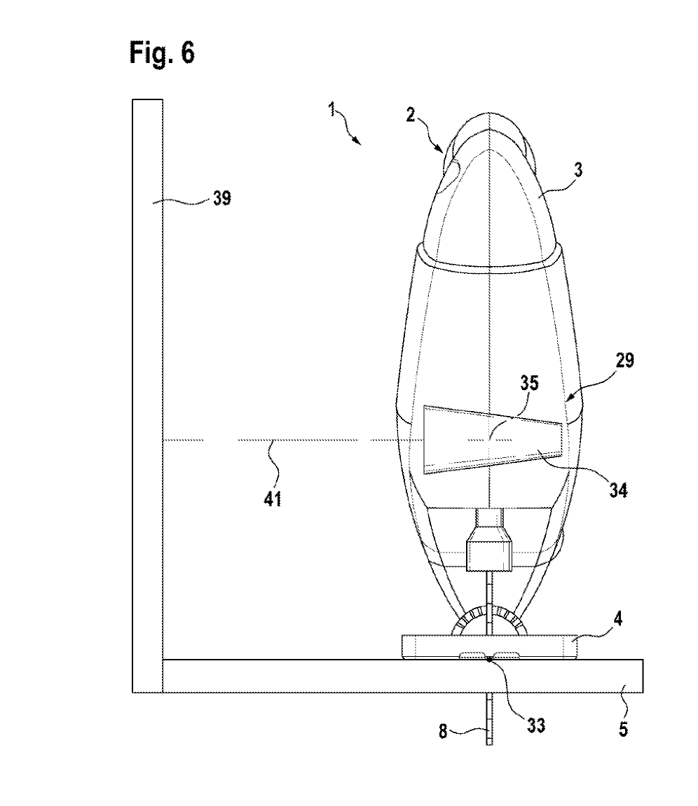

Thus, given the same configuration of the jigsaw 2 with regard to the attachment of the sensing arrangement 34, which is preferably connected and supplied via a flexible cable connection, the length of which can be changed optionally by being pulled out, specified paths can be sensed in quite different positions with respect to the workpiece 5 and to the jigsaw 2, with it being possible for a specified path 31 to be provided in a manner positioned on the workpiece or in a manner positioned off the workpiece 5, for example to be formed by a wall 39 (see FIG. 6) located next to the workpiece 5.

In the illustration according to FIG. 3, a separate reference part 40, which is formed as an abutment having a scale, is used as specified path 31, and so specified dimensions with regard to the travel to be covered along the work path 33 in a manner corresponding to the specified path 31 can also be transmitted via the measuring beam 41 of the sensing arrangement 34, given appropriately subordinate processing in the computing unit 21 and/or control unit 22.

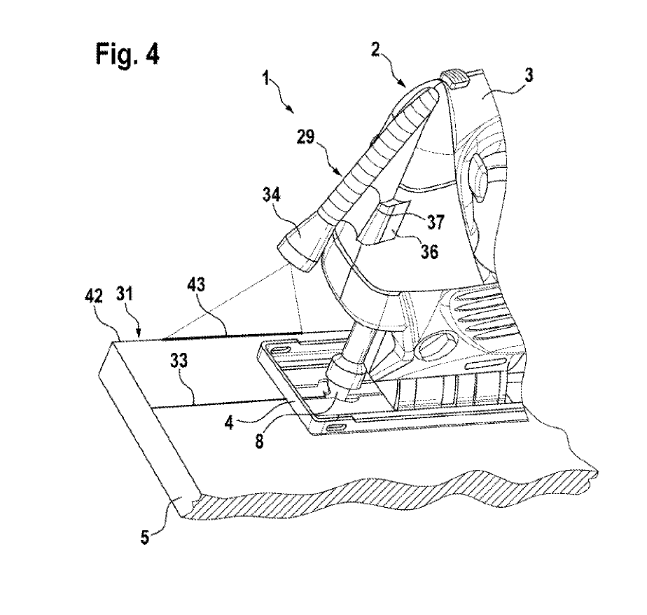

Analogously to FIG. 3, FIG. 4 also shows a workpiece-side specified path 31, specifically by way of an edge 42 of the workpiece 5, with respect to which a work path 33, which is located in a laterally offset position, is intended to be traced with the saw blade 8 as work tool 7. Here too, the specified path 31 is sensed via a course section 43, formed by a longitudinal section of the edge 42, this being possible for example with a sensing arrangement 34 using a camera, and the desired work path 33 located in an offset position with respect to the specified path 31 formed by the edge 42 is traced in a manner corresponding to the extent of the course section 43 via the alignment of the saw blade 8. In order to make the guiding work easier for the user of the jigsaw 2, in particular in order to make it easier for the user to control and orient the jigsaw with respect to the course of the work path 33 to be traced, it can be expedient, as described above, to make the work path 33 virtually visible to the user, for example via a corresponding signal beam or a projection onto the surface of the workpiece 5.

With respect to the arrangement of the sensing arrangement 34 in relation to the housing 3 of the jigsaw 2, FIG. 4 illustrates an arrangement which is laterally offset at the front and is aligned in an oblique manner with respect to the specified path 31 that is laterally offset with respect to the work path 33, and which is taken into account in the computing unit 21 also with regard to the specified offset between the specified path 31 and the work path 33 for the presentation of the work path 33 and the alignment of the saw blade 8 on the work path 33.

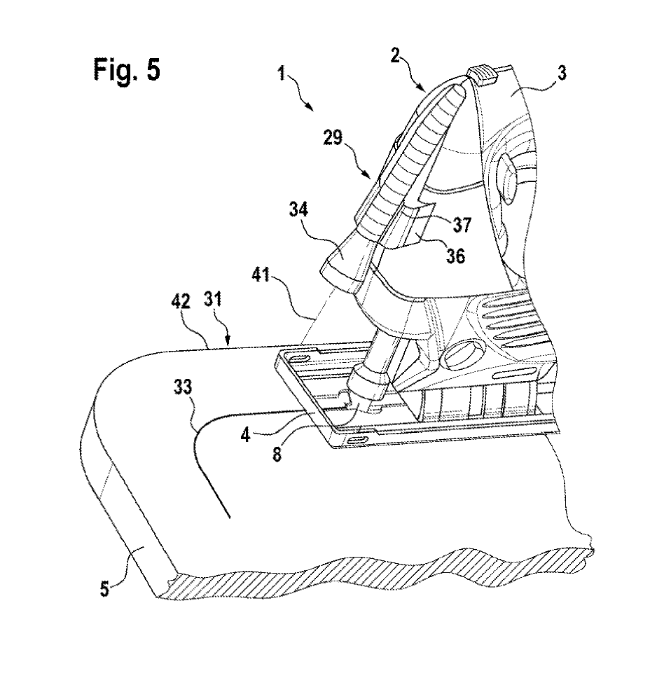

FIG. 5 shows an illustration corresponding to FIG. 4 on the machine side, it now being intended for a rounded specified path 31, formed by an edge 42 of the workpiece 5, as work path 33 to be traced by the saw blade 8 on the workpiece 5. In this case, the height offset, given between the specified path 31 and the work path 33 to be traced, of the rotational axis 12, illustrated in FIG. 1, of the saw blade 8 perpendicularly to the edge 42, or perpendicularly to the respective tangent to the edge 42, is taken into account.

FIG. 6 shows the sensing arrangement 34 in a transverse position, aligned in the direction of the wall 39, with respect to the working direction, which can be set for example by pivoting about the axis 35. The sensing arrangement 34 is thus aligned, transversely to the vertical axis of the jigsaw 2, with the wall 39, and the wall 39 forms the laterally spaced-apart specified path 31 for the work path 33 to be traced by the saw blade 8. As a result, a work path that follows the course of the wall 39 can be specified in a particularly simple manner.

1. A power tool, comprising:
a work tool; and
an auxiliary device configured to guide the work tool of the power tool along a work path to be followed on the workpiece side in a manner oriented with respect to a specified path that extends in a laterally offset manner with respect to the power tool,
wherein the auxiliary device has a distance measuring unit for contactlessly sensing a course section of the specified path and the distance of the work tool from the specified path in the course section and also a display device for the work path to be followed by the work tool at a specified distance from the specified path.

2. A power tool, comprising:
a work tool; and
an auxiliary device configured to align the work tool of the power tool with a work path to be followed on the workpiece side in a manner oriented with respect to a specified path that extends in a laterally offset manner with respect to the power tool,
wherein the auxiliary device has a distance measuring unit for contactlessly sensing a course section of the specified path and the distance of the work tool from the specified path in the course section, and also an actuating device for aligning the work tool with the work path and/or for guiding the work tool along the work path, which extends at a specified distance from the specified path on the workpiece side.

3. The power tool as claimed in claim 1, wherein the distance measuring unit is formed as a measuring unit that operates with an optical mechanism.

4. The power tool as claimed in claim 1, wherein the distance measuring unit is in the form of a measuring unit that operates with an acoustic mechanism.

5. The power tool as claimed in claim 1, wherein the distance measuring unit is fixed to the housing of the power tool by way of its sensing arrangement.

6. The power tool as claimed in claim 2, wherein the power tool is in the form of a jigsaw having a saw blade which is aligned with the work path via the actuating device about a rotational axis that extends in its longitudinal direction.

7. The power tool as claimed in claim 1, further comprising a computing unit, wherein the course of the work path corresponding to the specified path is determined via the computing unit and visualized via the display device.

8. The power tool as claimed in claim 3, wherein the optical mechanism includes a sensor system.

9. The power tool as claimed in claim 8, wherein the sensor system includes a camera.

10. The power tool as claimed in claim 4, wherein the distance measuring unit is in the form of a measuring unit that operates on the basis of ultrasound.

11. The power tool as claimed in claim 5, wherein the distance measuring unit is adjustably fixed to the housing.

12. The power tool as claimed in claim 6, wherein the jigsaw is a semi-autonomously operating jigsaw.
